(19) United States
(12) Patent Application Publication
(10) Pub. No.: US 2017/0218829 A1
(43) Pub. Date: Aug. 3, 2017

(54) EXHAUST MANIFOLD FOR A MULTICYLINDER INTERNAL COMBUSTION ENGINE

(71) Applicant: Scania CV AB, Söderälje (SE)

(72) Inventors: Dennis KONSTANZER, Spånga (SE); Kim PETERSSON, Söderälje (SE)

(21) Appl. No.: 15/500,794

(22) PCT Filed: Aug. 21, 2015
(86) PCT No.: PCT/SE2015/050890

§ 371 Date: Jan. 31, 2017

(30) Foreign Application Priority Data
Sep. 3, 2014 (SE) 1451026-7

(51) Int. Cl. F01N 13/10; F02B 75/18

(52) U.S. Cl. CPC F01N 13/107; F02B 75/18

(57) ABSTRACT

The present invention relates to a manifold for receiving exhausts from a multi-cylindrical internal combustion engine. The internal combustion engine has such a firing order that the riser in the manifold receives exhausts from two cylinders during an overlapping stage, simultaneously via an inlet opening arranged upstream and from an inlet opening arranged downstream in the riser. The riser comprises a substantially constant cross sectional area, except in one area, which is located in a position in connection with the inlet opening arranged downstream of the two inlet openings, receiving exhausts simultaneously. Said area has a geometry facilitating receipt and flow of exhausts in the predetermined direction in the riser, on occasions when the two inlet openings receive exhausts simultaneously.

### CROSS-REFERENCE TO RELATED APPLICATION(S)

This application is a national stage application (filed under 35 §U.S.C. 371) of PCT/SE15/050890, filed Aug. 21, 2015 of the same title, which, in turn claims priority to Swedish Application No. 1451026-7, filed Sep. 3, 2014 of the same title; the contents of each of which are hereby incorporated by reference.

### FIELD OF THE INVENTION

The present invention relates to a manifold for receiving exhausts from a multi-cylinder internal combustion engine.

### BACKGROUND OF THE INVENTION

Exhausts from multi-cylindrical internal combustion engines are usually received in a manifold. A manifold comprises several branch lines that receive exhausts from the internal combustion engine's cylinders and a riser that receives the exhausts from the respective branch lines. Each cylinder generally comprises two exhaust valves. When the exhaust valves open, exhausts flow out into the connecting branch line with a high pressure, which is substantially related to the pressure of the exhausts in the cylinder right after the combustion stroke has ended. The pressure of the exhausts in the branch line during the remaining time, during which the exhaust valve is open, is lower and substantially related to the work of the piston in the cylinder when it presses the exhausts out into the branch line. The exhaust valves in the cylinders are normally open during the entire exhaust stroke, i.e. during a relatively large part of a four stroke engine's working cycle. The more cylinders in an internal combustion engine that are connected to a manifold, the harder it is to prevent the exhaust valves' opening times of several cylinders from overlapping at some time during the working cycle. In a manifold receiving exhausts from four cylinders, it is substantially impossible to create a firing order, such that the inlet opening times of the exhaust valves do not overlap each other at some point. On such occasions, exhausts are thus led out into the riser from several cylinders simultaneously.

It is not uncomplicated to lead exhausts out from several cylinders simultaneously into a riser. When a cylinder opens at the same time as exhausts are led out of another cylinder with a lower pressure, there is an obvious risk that the exhausts with the higher pressure penetrate down into the branch line ejecting exhausts with the lower pressure. Thus, the pressure in this branch line increases and the piston in this cylinder must work harder to eject the exhausts. The increased ejection work results in an increased fuel consumption of the internal combustion engine.

U.S. Pat. No. 5,860,278 shows a riser for receipt of exhausts from an internal combustion engine via a number of branch lines. The riser comprises constrictions in connection with all the outlets of the branch lines. Thus, the exhausts in the riser obtain an increased speed and a reduced static pressure in connection with the outlets in the riser. Accordingly, exhausts with a lower pressure may be ejected into the riser. However, the adaptation of the riser with constrictions at all outlets has the disadvantage of relatively large exhaust flow losses in the riser.

### SUMMARY OF THE INVENTION

The objective of the present invention is to provide a manifold with a riser facilitating receipt of exhausts from two cylinders simultaneously, without significantly increasing the work of the internal combustion engine to eject the exhausts via the manifold.

This objective is achieved with a manifold for receiving exhausts from a multi-cylindrical internal combustion engine, wherein the manifold comprises at least three branch lines, each of which is adapted to receive exhausts from one of the internal combustion engine's cylinders, and a riser adapted to lead exhausts in a predetermined direction, and inlet openings in various positions located downstream in the riser in order to receive exhausts from the respective branch lines, wherein the internal combustion engine has such a firing order that the riser receives exhausts from two cylinders during an overlapping stage, simultaneously via an inlet opening arranged upstream and from an inlet opening arranged downstream in the riser. Since the firing order for the internal combustion engine's cylinders is known, the cylinders that eject exhausts simultaneously into the manifold are also known. The exhausts from the cylinders are led, via branch lines, into the riser's inlet openings, which are arranged in different positions arranged downstream in relation to each other. According to the invention, the cylinders with exhaust strokes overlapping each other and those inlet openings in the riser where exhausts simultaneously are received are determined in advance. Against the background of these facts, the riser is equipped with an area that has a geometry facilitating the receipt and flow of exhausts in the predetermined direction in the riser, on occasions when the two inlet openings receive exhausts simultaneously. This area is arranged in a position in connection with that inlet opening of the riser's two simultaneously exhaust receiving inlet openings, which is arranged downstream. In an area with such a geometry, inescapably larger flow losses are created than in other parts of the riser, which have a constant cross sectional area and advantageously a substantially straight extension. Since the riser only comprises an area with such a different geometry, the flow resistance to the exhausts in the manifold becomes significantly smaller than if the riser were equipped with several such areas with differing geometries, and in connection with all the inlet openings in the riser.

According to one embodiment of the present invention, said area is arranged in a position immediately upstream of the inlet opening arranged downstream. Thus, the exhausts from the inlet opening arranged upstream may be accelerated to a suitable speed, before they come into contact with the exhausts led into the riser via the inlet opening arranged downstream.

According to one embodiment of the present invention, the flow passage in said area has a successively reduced cross sectional area at an outlet end in relation to at an inlet end of said area. The cross sectional area in the area may have a reduction in the range of 10-40%. Through such a reduction of the cross sectional area, the speed of the exhausts from the inlet opening arranged upstream may be substantially increased, before they come into contact with the exhausts that are led into the riser via the inlet opening arranged downstream, without the flow resistance of the exhausts becoming too great when they pass through said area.

According to another preferred embodiment of the present invention, the riser comprises a wall construction that comprises an internal wall surface defining the flow passage through said area. In this case, the riser's wall construction may be given a shape, such that the internal wall surface defines the flow passage's geometry in said area. Alternatively, the riser may be equipped with internal separate flow elements, attached inside the riser, which are shaped in such a manner that they create the geometry of the flow passage in said area.

According to another preferred embodiment of the present invention, the riser's wall construction has an internal wall side, which faces the internal combustion engine comprising said inlet openings and an external wall side, which faces away from the internal combustion engine. In this case, the inlet openings may be arranged in a row on the internal wall side.

According to another preferred embodiment of the present invention, the internal combustion engine has such a firing order that the riser already receives an existing exhaust flow, via the inlet opening arranged downstream, at a time when an initial exhaust flow is received in the riser via the inlet opening arranged upstream. When an exhaust valve in a cylinder opens, an initial exhaust flow with a high pressure is obtained, following which the pressure drops during a remaining part of the exhaust stroke. In this case, exhausts with the higher pressure are led into the exhaust conduit via the inlet opening arranged upstream in the riser. The riser's internal wall side may have an angle in said area in relation to the primary flow direction of the exhausts in other parts of the riser, which angle defines the geometry of the flow passage in the area. When the exhaust flow reaches this area, it obtains an increased speed and a reduced static pressure. The reduced static pressure means that the exhausts with the lower pressure may be led into the riser via the inlet opening arranged downstream.

Said angle in the area also results in the exhausts with the higher pressure flowing at a distance from the inlet opening arranged downstream. Accordingly, space, where they may flow into the riser, is created for the exhausts with the lower pressure.

According to another preferred embodiment of the present invention, the branch line leading exhausts to the riser, via the inlet opening arranged downstream, comprises an internal wall surface with a tapered portion, which gives the inlet opening a successively expanding cross sectional area. With the help of such a tapered portion, an exhaust vortex is created in the inlet opening arranged downstream. Such an exhaust vortex efficiently prevents the exhausts in the riser from being led down into the branch line via the inlet opening.

According to one preferred embodiment of the present invention, the internal combustion engine has such a firing order that the riser already receives an existing exhaust flow, via the inlet opening arranged upstream, at a time when an initial exhaust flow is received in the riser via the inlet opening arranged downstream. In this case, exhausts with the lower pressure are led into the exhaust conduit via the inlet opening arranged upstream in the riser. The riser's second wall side may have a wedge-shaped portion in said area, comprising a first wall surface with a gradient, such that it reduces the cross sectional area of the flow passage in the riser, and a subsequent second wall surface with a gradient, such that it expands the cross sectional area of the flow passage in the riser, wherein the wedge-shaped portion is arranged in such a position that the exhaust flow, which has been led into the riser via the inlet opening arranged downstream, hits the second wall surface. The first wall surface of the wedge-shaped portion directs the exhaust flow with the lower pressure toward the exhausts with the higher pressure, which flow out from the inlet opening arranged downstream. The second wall surface of the wedge-shaped portion has a gradient, such that it leads the exhausts with the higher pressure in the intended flow direction in the riser. The second wall surface may have a substantially parallel extension with the exhaust flow, which flows out of the inlet opening arranged downstream. The wedge-shaped portion substantially prevents any part of the exhausts with the higher pressure from being led into an incorrect counterflow direction in the riser.

According to one preferred embodiment of the present invention, the wedge-shaped portion has a height, which is in the range of 3-10% of the diameter of the flow passage in the riser. The wedge-shaped portion may have a height of approximately 5% of the diameter of the flow passage. Thus, the wedge-shaped portion protrudes a relatively small distance into the second riser. The flow losses in the area are accordingly relatively minor. The first wall surface advantageously has a smaller angle in relation to the primary flow direction in the riser than has the second wall surface. The first wall surface may have an angle of approximately 5°, and the second wall surface may have an angle of approximately 1° in relation to the flow direction in the riser 4b. It is thus sufficient for the exhausts with the higher pressure to hit a second wall surface with a small enough angle in relation to the intended flow direction in the riser, to prevent that exhausts with the higher pressure are led into an incorrect direction in the riser.

According to one preferred embodiment of the present invention, the manifold is made of a cast material. Said areas located in the risers have geometries, which may be created relatively easily in a casting process.

The invention also relates to an internal combustion engine comprising a manifold as described herein. The internal combustion engine comprises at least three cylinders. A internal combustion engine with six or more cylinders may comprise a first manifold on a first side in order to receive exhausts from three or more cylinders, and a second manifold, which is arranged on an opposite side in order to receive exhausts from a remaining number of cylinders. Such an internal combustion engine may be a V8-engine.

### BRIEF DESCRIPTION OF THE DRAWING

Below is a description, as an example, of preferred embodiments of the invention with reference to the enclosed drawings, on which:

FIG. 1 shows a first manifold and a second manifold, each of which receives exhausts from four cylinders in an internal combustion engine,

FIG. 2 shows a cross sectional view of the first manifold in an area A-A in FIG. 1, and

FIG. 3 shows a cross sectional view of the second manifold in an area B-B in FIG. 1.

### DETAILED DESCRIPTION OF THE INVENTION

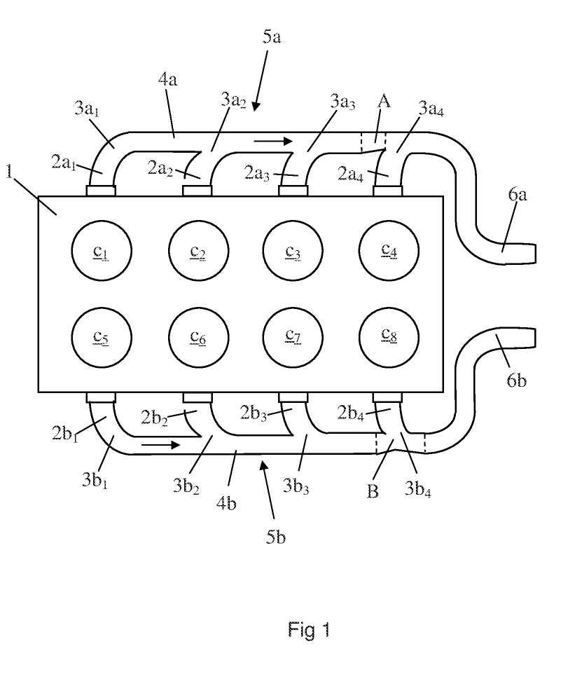

FIG. 1 shows an internal combustion engine 1 with eight cylinders c₁₋₈. The internal combustion engine 1 in this case is a V8 engine. Each one of the cylinders c₁₋₈ is connected with a branch line 2a₁₋₄, 2b₁₋₄ that ejects exhausts from the respective cylinders c₁₋₈. The exhausts from the cylinders c₁₋₄ on one of the sides of the internal combustion engine 1 are led, via branch lines 2a₁₋₄ and inlet openings 3a₁₋₄, to a first riser 4a. The exhausts from the cylinders c₅₋₈ on the other side of the internal combustion engine 1 are led, via branch lines 2b₁₋₄ and inlet openings 3b₁₋₄, to a second riser 4b. The branch lines 2a₁₋₄ and the riser 4a define a first manifold 5a. The first manifold 5a transitions into a first exhaust conduit 6a, which leads the exhausts to a non-displayed turbo charger. The manifolds 2b₁₋₄ and the riser 4b define a second manifold 5b. The second manifold 5b transitions into a second exhaust conduit 6b, which leads the exhausts to a non-displayed turbo charger.

The exhaust flow from each one of the cylinders c₁₋₈ is controlled by at least one exhaust valve, which is arranged in such a manner that it may be shifted between a closed state and an open state. Usually, each one of the cylinders c₁₋₈ is equipped with two exhaust valves to facilitate the ejection of the exhausts. When the exhaust valves open, initially an exhaust flow with a high pressure is ejected from the cylinders c₁₋₈, via the respective branch lines 2a₁₋₄, 2b₁₋₄ and the inlet opening 3a₁₋₄, 3b₁₋₄ to the risers 4a, 4b. For the remainder of the duration when the cylinders c₁₋₈ are open, the exhausts are ejected with a lower pressure to the risers 4a, 4b. This lower pressure is substantially defined by the movements of the piston in the cylinders c₁₋₈, when it presses the exhausts out into the respective branch lines 2a₁₋₄, 2b₁₋₄ Since each of the manifold's risers 4a, 4b receives exhausts from four cylinders cats, it is substantially impossible to avoid that the opening times of the exhaust valves of at least two cylinders c₁₋₈ overlap. The risers 4a, 4b will thus receive exhausts from more than one cylinder c₁₋₈ during a certain part of the internal combustion engine's working cycle.

The firing order for the internal combustion engine's cylinders c₁₋₈ is in this case c₁, c₅, c₄, c₂, c₆, c₃, c₇, c₈. With such a firing order the exhaust valves of the cylinders c₂, c₄ will be open simultaneously. The exhaust valve of the cylinder c₂ opens when the exhaust valve of the cylinder c₄ is already open. When this happens, exhausts with a high pressure are ejected from the branch line 2a₂, while exhausts with a lower pressure are ejected from the branch line 2a₄. In a conventional manifold, in this case a part of the exhausts flowing through the first riser 4a with a high pressure will be led into the branch line 2a₄. Accordingly, the pressure rises in the branch line 2a₄, where exhausts are ejected with a lower pressure. Accordingly, the piston in the cylinder c₄ must work harder to pump out the exhausts. With the above mentioned firing order the opening times of the exhaust valves of the cylinders c₇, c₈ will also overlap. In this case, the exhaust valve of the cylinder c₈ opens, when the exhaust valve of the cylinder c₇ is already open. When this happens, exhausts with a high pressure are ejected from the branch line 2b₄, while exhausts with a lower pressure are ejected from the branch line 2b₃. In a conventional manifold a part of the exhausts that flows through the manifold 2b₄ with a high pressure will be led in the wrong direction in the second riser 4b. Thus, the pressure in the branch line 2b₃ rises when exhausts are ejected with a lower pressure. Accordingly, the piston in the cylinder c₇ must work harder to pump out the exhausts.

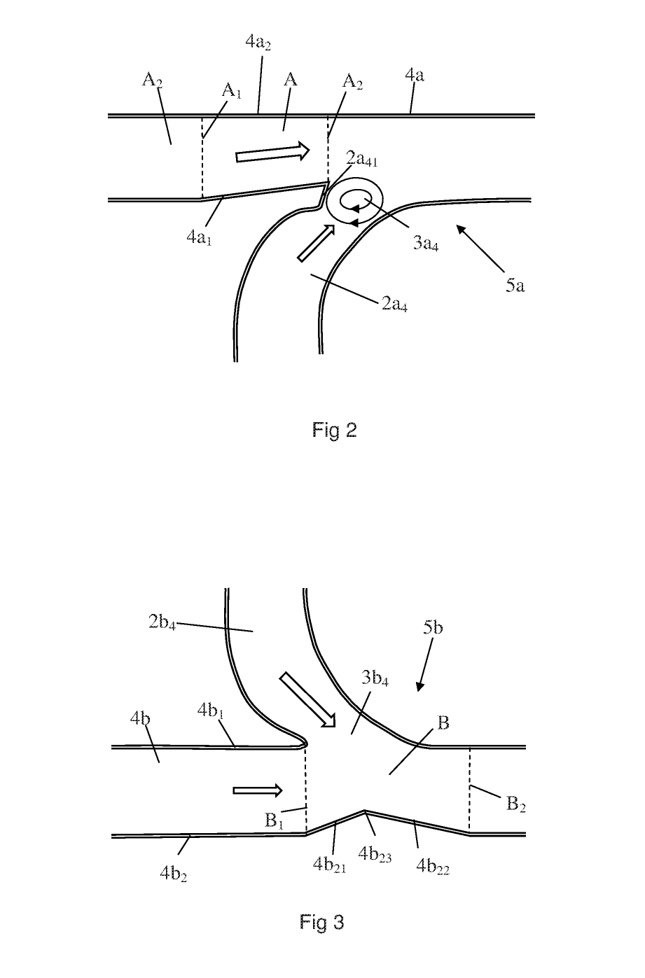

FIG. 2 shows a cross sectional view through the connecting area, where the branch line 2a₄ ejects exhausts into the first riser 4a. The first riser 4a has an inner wall side 4a₁ located on the same side as the branch lines 2a₁₋₄ and the inlet openings 3a₁₋₄. The first riser 4a has an external wall side 4a₂ located on an opposite side of the branch lines 2a₁₋₄ and the inlet openings 3a₁₋₄. The first riser 4a has an area A, with an extension from an inlet A₁ to an outlet A₂. The outlet A₂ is located in connection with the inlet opening 3a₄, where the riser 4a receives exhausts from the branch line 2a₄. The first riser 4a comprises a flow passage with a substantially constant cross sectional area upstream and downstream of the area A, with respect to the intended flow direction of the exhausts in the riser 4a. In the area A, the inner wall side 4a₁ of the first riser 4a has an angle in relation to the primary flow direction of the exhaust flow in the first riser 4a. Upstream and downstream of the first area A, the first riser's 4a inner wall side 4a₁ has a linear extension, which is substantially parallel with the primary flow direction of the exhaust flow in the first riser 4a. The second riser's 4a external wall side 4a₂ has a substantially linear extension in the entire riser 4a. The first riser's inner wall side 4a₁ has a gradient, such that the distance between the inner wall side 4a₁ and the outer wall side 4a₂ subsides continuously from the inlet A₁ to the outlet A₂ in the first area A. In this case the distance subsides linearly. Thus, a successively narrowing cross sectional area is created for the exhaust flow in the first area A. The branch line 2a₄, which leads exhausts to the riser 4a via the inlet opening 3a₄, comprises a wall surface with a tapered portion 2a₄₁, providing the inlet opening 3a₄ with an expanding cross sectional area. With such a tapered portion, the inlet opening 3a₄ obtains a funnel-like shape. In an inlet opening 3a₄ with such a shape, an exhaust vortex is formed. It may be noted that the inward bend in the area A has been exaggerated in the figures, in order to more clearly exemplify the invention.

On occasions when the exhaust valves in the cylinder c₄ are open and when the exhaust valves in the cylinder c₂ open, a powerful initial exhaust flow is provided from the cylinder c₂, via the second branch line 2a₂ and the inlet opening 3a₂, to the riser 4a. When this exhaust flow reaches the area A, the exhaust flow provides an acceleration through the subsiding cross sectional area. The first riser 4a may have a reduced cross sectional area in the range of 10-40%, for example 30%, at the outlet A₂ in relation to at the inlet A₁ of the area A. Accordingly, the exhausts that leave the first area A obtain a reduced static pressure in connection with the inlet opening 3a₄. Accordingly, the propensity of the exhaust flow leaving the area A to penetrate into the branch line 2a₄ is counteracted. The inner wall side 4a₁ thus has an angle in relation to the exhaust flow's primary flow direction in the first area A. The inner wall side 4a₁ has an angle, such that the exhaust flow obtains a relatively soft directional change in connection with the first wall side 4a₁ in the area A. The inner wall side 4a₁ reduces the exhaust flow in the area A on the side where the first riser 4a receives exhausts via the inlet opening 3a₄. The directional change, which the exhaust flow obtains in the first area A, in connection with the inner wall side 4a₁, means that the exhaust flow is led in a direction partly away from the inlet opening 3a₄. This makes it even more difficult for the exhausts leaving the area A to penetrate into the branch line 2a₄. At the same time, an area is created in the riser 4a into which the exhausts with the lower pressure, leaving the branch line 2a₄, may be led. The exhaust vortex formed in the funnel shaped area of the branch line 2a₄ in connection with the inlet opening 3a₄ also makes it difficult for the exhausts leaving the area A to penetrate into the branch line 2a₄.

FIG. 3 shows a cross sectional view through the connecting area, where the second riser 4b receives exhausts from the branch line 2b₄ via the inlet opening 3b₄. The second riser 4b has an inner wall side 4b₁, located on the same side as the branch line 2b₄ and the inlet opening 3b₄. The second riser 4b has an outer wall side 4b₂, located on an opposite side of the branch line 2b₄ and the inlet opening 3b₄. The second riser 4b has an area B, which extends from an inlet B₁ to an outlet B₂. The first riser 4b comprises a flow passage with a substantially constant cross sectional area upstream and downstream of the area B, with respect to the intended flow direction of the exhausts in the riser 4b.

The second riser's 4b outer wall side 4b₂ has a wedge-shaped portion in the second area B, comprising a first wall surface 4b₂₁ with a gradient, such that it reduces the cross sectional area of the flow passage in the riser 4b, and a subsequent second wall surface 4b₂₂ with a gradient, such that it expands the flow passage's cross sectional area in the riser 4b. It may be noted that the inward bend in the area B has been exaggerated in the figures, in order to exemplify the invention more clearly

The first wall surface 4b₂₁ and the second wall surface 4b₂₂ have a breaking point 4b₂₃. The wedge-shaped portion is arranged in such a position that the exhaust flow led into the riser 4b, via the inlet opening 3b₄ arranged downstream, only hits the second wall surface 4b₂₂. The entire exhaust flow from the branch line 2b₄ thus hits to the right of the breaking point 4b₂₃. The exhaust flow from the branch line 2b₄ should, however, hit as close to the breaking point 4b₂₃ as possible.

The wedge-shaped portion has a height in the range of 3-10% of the flow passage's diameter in the riser 4b. The wedge-shaped portion may have a height of approximately 5% of the diameter of the flow passage. Thus, the wedge-shaped portion protrudes a relatively small distance into the second riser 4b. The flow losses in the area are accordingly relatively minor. The first wall surface 4b₂₁ has an angle of approximately 1° in relation to the primary flow direction in the riser, and the second wall surface 4b₂₂ has an angle of approximately 5° in relation to the primary flow direction in the riser 4b. It is thus sufficient that the second wall surface has a sufficiently small angle to direct the exhausts are leaving the branch line 2b₄ and hitting the surface in a desired direction in the riser 4b. The second riser's 4b outer wall side 4b₂ has, upstream and downstream of the area B, a linear extension that is parallel with the primary flow direction of the exhaust flow in the second riser 4b. The second riser's 4b inner wall side 4b₁ has a substantially linear extension.

On occasions when the exhaust valves of the cylinder c₇ are open and when the exhaust valves of the cylinder c₈ open, a powerful initial exhaust flow is provided from the cylinder c₈, via the branch line 2b₄ and the inlet opening 3b₄, to the second riser 4b. At the same time, exhausts with a lower pressure are led from the cylinder c₇, via the branch line 2b₃ and the inlet opening 3b₃, to the second riser 4b. The first wall surface 4b₂₁ of the wedge-shaped portion directs the exhaust flow with the lower pressure toward the exhausts with the higher pressure, which flow out of the inlet opening 3b₄ arranged downstream. The second wall surface 4b₂₂ of the wedge-shaped portion has a gradient, such that it leads the exhausts with the higher pressure in the intended flow direction in the riser 4b. The wedge-shaped portion prevents substantially any part of the exhausts with the higher pressure from being led into an incorrect counterflow direction in the riser 4b. Said areas A, B which are located in the risers 4a, 4b, have geometries which may be created in a casting process relatively easily. The manifolds 5a, 5b are thus advantageously made in a casting process.

The internal combustion engine 1 thus has two manifolds 5a, 5b, which receive exhausts from two different sides of the internal combustion engine 1. With knowledge about the internal combustion engine's firing order both the manifolds 5a, 5b have been equipped with areas A, B in connection with the inlet opening 2a₄, 2b₄ arranged downstream, for supply of exhausts from two cylinders c₂, c₄, c₇, c₈ having overlapping opening times of the exhaust valves. The areas A, B have sections with different geometries, in order to receive and lead the exhausts in a predetermined direction in the respective risers 4a, 4b on the different sides of the internal combustion engine 1, depending on if the inlet opening arranged downstream 2a₄, 2b₄ supplies exhausts with the higher pressure or the lower pressure.

The invention is in no way limited to the embodiment described above, but may be varied freely within the framework of the claims. The manifold may receive exhausts from a varying number of cylinders in an internal combustion engine.

1. A manifold for receiving exhausts from a multi-cylindrical internal combustion engine, wherein the manifold comprises at least three branch lines, each of which is adapted to receive exhausts from one of the cylinders of the internal combustion engine, and a riser adapted to lead exhausts in a predetermined direction, and inlet openings in various positions located downstream in the riser in order to receive exhausts from the respective branch lines, wherein the internal combustion engine has such a firing order that the riser receives exhausts from two cylinders during an overlapping stage, simultaneously via an inlet opening arranged upstream and from an inlet opening arranged downstream in the riser, wherein the riser comprises a flow passage with a substantially constant cross sectional area, except in one area located in a position in connection with the inlet opening arranged downstream of the two inlet openings, which receive exhausts simultaneously, wherein said area has a geometry which facilitates the receipt and the flow of exhausts in the predetermined direction in the riser on occasions when the two inlet openings receive exhausts simultaneously.

2. A manifold according to claim 1, wherein said area is located in a position immediately upstream of the inlet opening arranged downstream.

3. A manifold according to claim 1, wherein said area has a successively subsiding cross sectional area, from an inlet up to an outlet.

4. A manifold according to claim 1, wherein the riser comprises an internal wall surface, which defines the flow passage through said area.

5. A manifold according to claim 1, wherein the riser comprises a first wall side, comprising said inlet openings and a second opposite wall side, which is arranged on an opposite side of said inlet openings.

6. A manifold according to claim 1, wherein the internal combustion engine has such a firing order that the riser already receives an existing exhaust flow, via the inlet opening arranged downstream, at a time when an initial exhaust flow is received in the riser via the inlet opening arranged upstream.

7. A manifold according to claim 6, wherein the riser comprises a first wall side, comprising said inlet openings, and a second, opposite wall side, which is arranged on an opposite side of said inlet openings and in that the riser's first wall side has an angle in said area, in relation to the primary flow direction of the exhausts in other parts of the riser, which defines a successive subsiding of the cross sectional area of the flow passage in the area.

8. A manifold according to claim 7, wherein the manifold, which leads exhausts to the riser via the inlet opening, comprises an internal wall surface with a tapered portion giving the inlet opening an expanding cross sectional area.

9. A manifold according to claim 1, wherein the internal combustion engine has such a firing order that the riser already receives an existing exhaust flow, via the inlet opening arranged upstream, at a time when an initial exhaust flow is received in the riser via the inlet opening.

10. A manifold according to claim 9, wherein the riser comprises a first wall side, which comprises said inlet openings, and a second opposite wall side, arranged on an opposite side of said inlet openings, and in that the riser's second wall side has, in said area, a wedge-shaped portion comprising a first wall surface, with such a gradient that it reduces the flow passage's cross sectional area in the riser and a subsequent, second wall section with such a gradient that it expands the flow passage's cross sectional area in the riser, wherein the wedge-shaped portion is arranged in such a position that the exhaust flow led into the riser, via the inlet opening arranged downstream, hits the second wall surface.

11. A manifold according to claim 10, wherein the wedge-shaped portion has a height in the range of 3-10% of the diameter of the flow passage in the riser.

12. A manifold according to claim 10, wherein the first wall surface has a smaller angle in relation to the primary flow direction in the riser than has the second wall surface.

13. An internal combustion engine comprising at least one manifold for receiving exhausts from a multi-cylindrical internal combustion engine, wherein the manifold comprises at least three branch lines, each of which is adapted to receive exhausts from one of the cylinders of the internal combustion engine, and a riser adapted to lead exhausts in a predetermined direction, and inlet openings in various positions located downstream in the riser in order to receive exhausts from the respective branch lines, wherein the internal combustion engine has such a firing order that the riser receives exhausts from two cylinders during an overlapping stage, simultaneously via an inlet opening arranged upstream and from an inlet opening arranged downstream in the riser, wherein the riser comprises a flow passage with a substantially constant cross sectional area, except in one area located in a position in connection with the inlet opening arranged downstream of the two inlet openings, which receive exhausts simultaneously, wherein said area has a geometry which facilitates the receipt and the flow of exhausts in the predetermined direction in the riser on occasions when the two inlet openings receive exhausts simultaneously.

14. An internal combustion engine according to claim 13, comprising two of said manifolds as claimed in claim 13, wherein one of said manifolds is arranged on a first side of the internal combustion engine in order to receive exhausts from several cylinders, and said other of said manifolds is arranged on an opposite wall side of the internal combustion engine, in order to receive exhausts from a remaining number of cylinders.

15. A vehicle comprising an internal combustion engine comprising at least one manifold for receiving exhausts from a multi-cylindrical internal combustion engine, wherein the manifold comprises at least three branch lines, each of which is adapted to receive exhausts from one of the cylinders of the internal combustion engine, and a riser adapted to lead exhausts in a predetermined direction, and inlet openings in various positions located downstream in the riser in order to receive exhausts from the respective branch lines, wherein the internal combustion engine has such a firing order that the riser receives exhausts from two cylinders during an overlapping stage, simultaneously via an inlet opening arranged upstream and from an inlet opening arranged downstream in the riser, wherein the riser comprises a flow passage with a substantially constant cross sectional area, except in one area located in a position in connection with the inlet opening arranged downstream of the two inlet openings, which receive exhausts simultaneously, wherein said area has a geometry which facilitates the receipt and the flow of exhausts in the predetermined direction in the riser on occasions when the two inlet openings receive exhausts simultaneously.

16. A vehicle according to claim 15 comprising an internal combustion engine comprising two of said manifolds as claimed in claim 15, wherein one of said manifolds is arranged on a first side of the internal combustion engine in order to receive exhausts from several cylinders, and said other of said manifolds is arranged on an opposite wall side of the internal combustion engine, in order to receive exhausts from a remaining number of cylinders.
